(19) United States
(12) Patent Application Publication
(10) Pub. No.: US 2008/0113604 A1
(43) Pub. Date: May 15, 2008

(54) EMBEDDED COMPUTER CHASSIS WITH SERVICE FAN TRAY

(75) Inventors: Robert C. Tufford, Chandler, AZ (US); Mark S. Lanus, Tempe, AZ (US)

Correspondence Address: MOTOROLA, INC., LAW DEPARTMENT, 1303 E. ALGONQUIN ROAD, SCHAUMBURG, IL, 60196, US

(73) Assignee: MOTOROLA, INC., Schaumburg, IL (US)

(21) Appl. No.: 11/539,913

(22) Filed: Oct. 10, 2006

(51) Int. Cl. B01L 1/04

(52) U.S. Cl. 454/187

(57) ABSTRACT

An embedded computer chassis may include a fan tray receptacle adapted to receive at least one primary fan tray, where the at least one primary fan tray is adapted to be non-redundant in providing cooling air to the embedded computer chassis. Embedded computer chassis may also include a cooling air plenum, where the cooling air plenum is adapted to receive a service fan tray, where the service fan tray is adapted to temporarily provide the cooling air to the embedded computer chassis absent the at least one primary fan tray.

### BACKGROUND OF INVENTION

Existing embedded computer chassis generally employ forced air convection cooling of electronic modules. The forced air convection is achieved through use of one or more fan trays, each containing one or more fans. In the prior art, there may be a redundant number of fans in each fan tray, such that if a fan fails, the fan tray can continue to cool the embedded computer chassis adequately. Also in the prior art, there may be a redundant number of fan trays in the embedded computer chassis, such that if a fan tray is removed, the remaining fan trays can continue to cool the embedded computer chassis adequately.

Fan trays need to be removed for maintenance and replacement without interrupting the operation of the embedded computer chassis. For low-profile and/or low cost embedded computer chassis, interior volume is at a premium, and space is not available for a redundant fan tray. So, even though a fan tray may have a redundant number of fans, if the fan tray is removed for maintenance, the chassis will have to be shutdown, which is unacceptable from a quality of service standpoint. Despite only having a single fan tray, low-profile and low-cost systems must be highly-available and operate without interruption, even in the event of a faulty fan tray.

The prior art is deficient in providing a method for temporary redundancy for cooling in an embedded computer chassis. Accordingly, there is a significant need for an apparatus and method that overcomes the deficiencies of the prior art outlined above.

### BRIEF DESCRIPTION OF THE DRAWINGS

Representative elements, operational features, applications and/or advantages of the present invention reside inter alia in the details of construction and operation as more fully hereafter depicted, described and claimed—reference being made to the accompanying drawings forming a part hereof, wherein like numerals refer to like parts throughout. Other elements, operational features, applications and/or advantages will become apparent in light of certain exemplary embodiments recited in the Detailed Description, wherein:

FIG. 1 representatively illustrates an embedded computer chassis in accordance with an exemplary embodiment of the present invention;

FIG. 2 representatively illustrates an embedded computer chassis in accordance with another exemplary embodiment of the present invention;

FIG. 3 representatively illustrates a block diagram of an embedded computer chassis in accordance with an exemplary embodiment of the present invention; and

FIG. 4 representatively illustrates a flow diagram of a method in accordance with an exemplary embodiment of the present invention.

Elements in the Figures are illustrated for simplicity and clarity and have not necessarily been drawn to scale. For example, the dimensions of some of the elements in the Figures may be exaggerated relative to other elements to help improve understanding of various embodiments of the present invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “over”, “under”, and the like in the Description and/or in the Claims, if any, are generally employed for descriptive purposes and not necessarily for comprehensively describing exclusive relative position. Any of the preceding terms so used may be interchanged under appropriate circumstances such that various embodiments of the invention described herein may be capable of operation in other configurations and/or orientations than those explicitly illustrated or otherwise described.

### DETAILED DESCRIPTION OF EXEMPLARY EMBODIMENTS

The following representative descriptions of the present invention generally relate to exemplary embodiments and the inventor's conception of the best mode, and are not intended to limit the applicability or configuration of the invention in any way. Rather, the following description is intended to provide convenient illustrations for implementing various embodiments of the invention. As will become apparent, changes may be made in the function and/or arrangement of any of the elements described in the disclosed exemplary embodiments without departing from the spirit and scope of the invention.

The terms “a” or “an”, as used herein, are defined as one, or more than one. The term “plurality,” as used herein, is defined as two, or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

A detailed description of an exemplary application is provided as a specific enabling disclosure that may be generalized to any application of the disclosed system, device and method for a computer cooling system in accordance with various embodiments of the present invention.

FIG. 1 representatively illustrates an embedded computer chassis 100 in accordance with an exemplary embodiment of the present invention. Embedded computer chassis 100 may be defined by a plurality of outer surfaces including a front side 105 and a rear side 107. Embedded computer chassis 100 may include a card portion 106 having any number of slots suitably adapted for receiving one or more computer cards. For example, card portion 106 can be suitably adapted for receiving at least one of a payload card, switch card, rear transition module, and the like. In an embodiment, cards in card portion 106 may be coupled to a backplane, midplane, serpentine backplane, and the like.

Embedded computer chassis 100 may include hardware and software necessary to implement a data network using a parallel multi-drop topology, switched fabric topology, and the like. Backplane, midplane, and the like may be disposed substantially vertical or substantially horizontal within embedded computer chassis 100.

Each card disposed to interface with card portion 106 may include a printed circuit board (PCB) having any number of electronic devices located thereon, for example, and without limitation, processors, memory, storage devices, I/O elements, wireless and wireline communication elements, and the like.

Embedded computer chassis 100 may be adapted for use in any application requiring modular, embedded computing resources, for example and without limitation, telecommunications, industrial control, system control and data acquisition (SCADA), and the like. In the exemplary embodiment, embedded computer chassis 100 can be a 1U, 3U, 6U, 9U chassis, and the like. Embedded computer chassis 100 may be coupled together and “stacked” to form a distributed computing system coupled to share resources from each chassis.

As is known in the art, “U” and multiples of “U” can refer to both the width of a card and the height of the embedded computer chassis 100. In an embodiment, “U” can measure approximately 1.75 inches. Any size chassis or cards are within the scope of the invention. The “U” terminology is not limiting of the invention. As such, the invention is not limited to “U” as a form factor reference. Other form factor reference notations and increments are within the scope of the invention.

In an embodiment, embedded computer chassis 100 may include a backplane or midplane and a card portion 106 suitably adapted to operate a parallel multi-drop network, for example, a VERSAmodule Eurocard (VMEbus) network using any of the VMEbus protocols known in the art. VMEbus is defined in the ANSINITA 1-1994 and ANSINITA 1.1-1997 standards, promulgated by the VMEbus International Trade Association (VITA), P.O. Box 19658, Fountain Hills, Ariz., 85269 (where ANSI stands for American National Standards Institute). In an embodiment of the invention, VMEbus based protocols can include, but are not limited to, Single Cycle Transfer protocol (SCT), Block Transfer protocol (BLT), Multiplexed Block Transfer protocol (MBLT), Two Edge VMEbus protocol (2eVME) and Two Edge Source Synchronous Transfer protocol (2eSST). These VMEbus protocols are known in the art.

In another embodiment, embedded computer chassis 100 may include backplane or midplane and card portion 106 suitably adapted to operate a switched fabric. Switched fabric may use switch card as a central switching hub with any number of payload cards coupled to switch card. Switched fabric can be based on a point-to-point, switched input/output (I/O) fabric, whereby cascaded switch devices interconnect end node devices. In an embodiment, switched fabric can be configured as a star topology, mesh topology, and the like as known in the art for communicatively coupling switched fabrics. Switched fabric can include both card-to-card (for example computer systems that support I/O card add-in slots) and chassis-to-chassis environments (for example interconnecting computers, external storage systems, external Local Area Network (LAN) and Wide Area Network (WAN) access devices in a data-center environment). Switched fabric can be implemented by using one or more of a plurality of switched fabric network standards, for example and without limitation, InfiniBand™, Serial RapidIO™, FibreChannel™, Ethernet™, PCI Express™, AdvancedTCA™, Hypertransport™, Gigabit Ethernet, and the like. Switched fabric is not limited to the use of these switched fabric network standards and the use of any switched fabric network standard is within the scope of the invention.

In another embodiment, embedded computer chassis 100 may include backplane or midplane and card portion 106 suitably adapted to comply with CompactPCI® standard. In still another embodiment, embedded computer chassis 100 can include backplane or midplane and card portion 106 suitably adapted to may comply with MicroTCA standard as defined in PICMG® MicroTCA 1.0—Micro Telecom Compute Architecture Base Specification (and subsequent revisions).

In still yet another embodiment, embedded computer chassis 100 may include backplane or midplane and card portion 106 suitably adapted to operate a VXS network conforming to the VERSAmodule Eurocard (VMEbus) switched serial standard backplane (VXS) as set forth in VITA 41 promulgated by VMEbus International Trade Association (VITA), P.O. Box 19658, Fountain Hills, Ariz., 85269. The embodiment of the invention is not limited to a computer system complying with any of these standards, and computer systems complying with other standards are within the scope of the invention.

When in operation, cards disposed in card portion 106, among other devices, may generate heat that must be removed from embedded computer chassis 100. Embedded computer chassis 100 may include a fan tray receptacle 102 adapted to receive at least one primary fan tray 108, and a cooling air plenum 104. In an embodiment, fan tray receptacle 102 may be any size so as to receive at least one primary fan tray 108, where at least one primary fan tray 108 may be suitably adapted to slidably engage fan tray receptacle 102. The specific size and configuration of fan tray receptacle 102 can be tailored by one skilled in the art to fit a specific application and be within the scope of the invention. At least one primary fan tray 108 is adapted to couple backplane, midplane, and the like, of embedded computer chassis 100. For example, at least one primary fan tray 108 may couple to a backplane and receive power control signals via the backplane.

In an embodiment, at least one primary fan tray 108 may include any number of fans 113, which can include, for example and without limitation, centrifugal fans, axial fans, blowers, and the like. Fans 113 may be suitably configured in any combination of “push” or “pull” patterns and disposed at any appropriate angle in the at least one primary fan tray 108. Fans 113 may either “push” cooling air 109 over one or more computer cards or “pull” cooling air 109 over one or more computer cards, or any combination thereof. In pushing or pulling cooling air 109 over computer cards, cooling air 109 may flow over one or both sides of computer cards. As an example of an embodiment, at least one primary fan tray 108 may include one or more axial fans. The number and operating point of fans 113 can be chosen to fit a particular application and is well within the abilities of one of ordinary skill in the art. Although the embodiment shown illustrates fans 113 pushing cooling air 109, other configurations are within the scope of the invention, including fans 113 pulling cooling air 109 though embedded computer chassis 100.

In an embodiment, a surface of embedded computer chassis 100, for example front side 105 may include one or more orifices to allow cooling air 109 to be drawn into embedded computer chassis 100 in a direction substantially perpendicular to front side 105. Cooling air plenum 104 may include a cavity where cooling air 109 leaves embedded computer chassis 100 through for example rear side 107. Cooling air 109 may follow a substantially defined path through embedded computer chassis 100 such that heat is removed from card portion 106 and a given temperature range is maintained within embedded computer chassis 100. In an optional embodiment, a cooling air entry plenum may be located in the cooling air path such that the cooling air 109 passes through the cooling air entry plenum before the at least one primary fan tray 108. Although cooling air 109 is shown entering embedded computer chassis 100 through front side 105 and exiting through rear side 107, air may enter and exit embedded computer chassis 100 through any side or combination of sides and be within the scope of the invention.

In the embodiment shown, fan tray receptacle 102 is shown below card portion 106, while cooling air plenum 104 is shown above card portion 106. This is not limiting of the invention, as the fan tray receptacle 102 and cooling air plenum 104 may be disposed in any configuration in or around card portion 106 and be within the scope of the invention.

In an embodiment, the at least one primary fan tray 108 is not redundant in removing the heat generated in embedded computer chassis 100. In other words, when at least one primary fan tray 108 fails or is removed from embedded computer chassis 100, there will be inadequate cooling of card portion 106 and embedded computer chassis 100. There are no redundant fan tray receptacles, fan trays or locations for redundant fan trays that match the operability of at least one primary fan tray 108 in embedded computer chassis 100. Optionally, at least one primary fan tray 108 may include temperature sensors and other hardware and software modules to detect and react to temperature changes in embedded computer chassis 100.

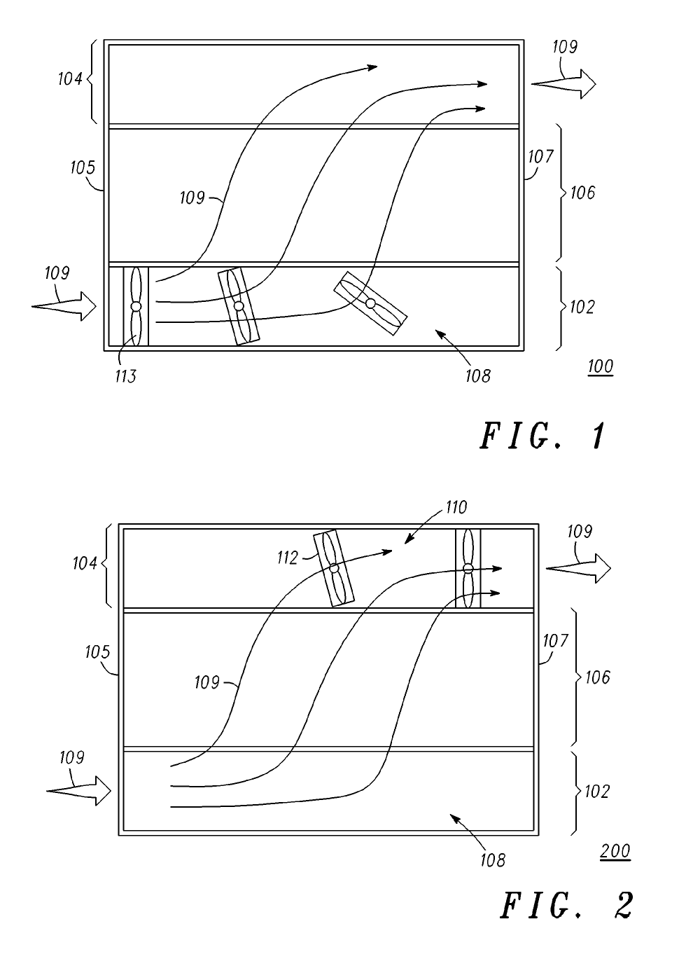

FIG. 2 representatively illustrates an embedded computer chassis 200 in accordance with another exemplary embodiment of the present invention. In the embodiment of FIG. 2, a service fan tray 110 is placed in the cooling air plenum 104 to temporarily provide cooling air 109 to the embedded computer chassis 200 absent the at least one primary fan tray 108.

Cooling air plenum 104 is adapted to receive service fan tray 110, where service fan tray 110 may comprise at least one service fan 112. In the event at least one primary fan tray 108 fails, or requires service that causes at least one primary fan tray 108 to be removed from fan tray receptacle 102 of embedded computer chassis 200, service fan tray 110 may be inserted into cooling air plenum 104 to temporarily provide cooling air 109 to embedded computer chassis 200 until at least one primary fan tray 108 can be returned to operation.

In the embodiment shown, at least one primary fan tray 108 “pushes” cooling air 109 through card portion 106, while service fan tray 110 “pulls” cooling air 109 though card portion 106. This configuration is not limiting of the invention. For example, at least one primary fan tray 108 may “'pull” cooling air 109, while service fan tray 110 “pushes” cooling air 109. In another example, both of at least one primary fan tray 108 and service fan tray 110 may “push” or “pull” cooling air 109, or any combination thereof.

In an embodiment, service fan tray 110 may include any number of service fans 112, which can include, for example and without limitation, centrifugal fans, axial fans, blowers, and the like. Service fans 112 may be suitably configured in any combination of “push” or “pull” patterns and disposed at any appropriate angle in the service fan tray 110. Service fans 112 may either “push” cooling air 109 over one or more computer cards or “pull” cooling air 109 over one or more computer cards, or any combination thereof. In pushing or pulling cooling air 109 over computer cards, cooling air 109 may flow over one or both sides of computer cards. As an example of an embodiment, service fan tray 110 may include one or more axial fans. The number and operating point of service fans 112 may be chosen to fit a particular application and is well within the abilities of one of ordinary skill in the art. Although the embodiment shown illustrates service fans 112 pulling cooling air 109, other configurations are within the scope of the invention, including service fans 112 pushing cooling air 109 though embedded computer chassis 200.

In an embodiment, at least one service fan 112 may operate at a single speed. In another embodiment, at least one service fan 112 may operate at multiple speeds or be variable speed. In another embodiment, service fan tray 110 may comprise any number of service fans 112 operating in any combination of single speed, multiple speeds and variable speed configurations.

In an embodiment, service fan tray 110 may provide cooling air 109 to embedded computer chassis 200 for a limited period of time such that computer cards in card portion 106 remain functional. For example, service fan tray 110 may be adapted to provide cooling air 109 for a limited period of time such that at least one primary fan tray 108 may be swapped out (i.e. one primary fan tray removed and another one inserted in its place). In another example, service fan tray 110 may provide cooling air 109 for a limited period of time only, such that the limited period of time is of a fixed duration. In yet another example, service fan tray 110 may provide cooling air 109 for an indefinite period of time.

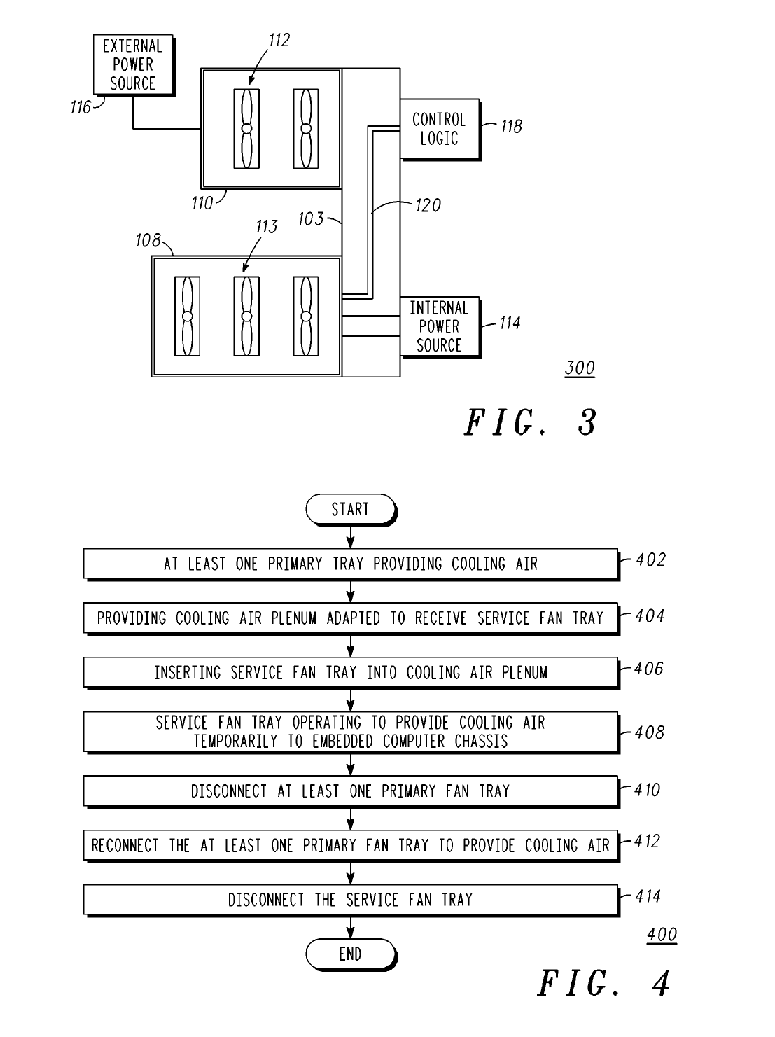

FIG. 3 representatively illustrates a block diagram of an embedded computer chassis 300 in accordance with an exemplary embodiment of the present invention. As shown in FIG. 3, embedded computer chassis 300 may include a backplane 103 (where backplane may be a backplane, midplane, and the like), operating control bus 120 transmitting and receiving control logic 118 from/to, for example, a controller unit.

Control logic 118 may be suitably adapted to power up at least one primary fan tray 108, monitor fans 113, and increase/decrease fans 113 to a selected speed based on feedback from one or more temperature sensors. At least one primary fan tray 108 may be suitably adapted to report fan management data over control bus 120, for example an Intelligent Platform Management Bus (IPMB). Fan management data may include, but is not limited to, temperature, fan speed, voltage, amperage, bus traffic, status indications, and the like.

In an embodiment, service fan tray 110 operates independently of control bus 120. In other words, in this embodiment service fan tray 110 does not interface with control bus 120 and does not operate with control logic 118. In this instance service fan tray 110 may operate, for example, at a single speed without utilizing feedback mechanisms (such as temperature sensors) to vary service fan speed. In a variation of this embodiment, service fan tray 110 does not interface with backplane, but merely is inserted into cooling air plenum 104.

In another embodiment, service fan tray 110 is coupled to control bus 120 and operates in conjunction with control logic 118, similar to at least one primary fan tray 108. In this embodiment, service fan tray 110 may be connected to control bus 120 and report fan management data similar to at least one primary fan tray 108.

In an embodiment, embedded computer chassis 300 includes an internal power source 114 that provides power to embedded computer chassis 300, including at least one primary fan tray 108. For example, internal power source 114 may provide power to at least one primary fan tray 108 through backplane 103. Internal power source 114 may include a transformer to convert alternating current to direct current, battery system, and the like, where internal power source 114 is dedicated to providing power to embedded computer chassis 300.

In another embodiment, service fan tray 110 operates from an external power source 116 that is independent from internal power source 114 of the embedded computer chassis 300. External power source 116 is a separate and independent power source from internal power source 114. In an embodiment, external power source 116 is not delivered over backplane 103, but may be supplied to service fan tray 110, for example, via external connectors, and the like. External power source 116 may include a separate conducting path to, for example, a wall outlet, a battery, a backup generator, a fuel cell, and the like. External power source 116 may be self-contained, for example a power source that is on-board service fan tray 110, such as a battery, and the like. In this embodiment, external power source 116 allows service fan tray 110 to operate independently of the internal power source 114 supplying power to embedded computer chassis 300. In another embodiment, service fan tray 110 may be coupled to backplane and operate from internal power source 114.

Although at least one primary fan tray 108 is shown with three fans 113 and service fan tray is shown with two service fans 112, this is not limiting of the invention. At least one primary fan tray 108 and service fan tray 110 may each have any number of fans respectively. Further, service fan tray 110 need not have fewer or more fans than primary fan tray 108. Each of primary fan tray 108 and service fan tray 110 may include any number of fans as determined by one skilled in the art to provide cooling as required for a particular application.

FIG. 4 representatively illustrates a flow diagram 400 of a method in accordance with an exemplary embodiment of the present invention. In step 402, at least one primary fan tray is providing cooling air to the embedded computer chassis, where the at least one primary fan tray is non-redundant in providing the cooling air. In step 404, a cooling air plenum is provided that is adapted to receive a service fan tray. The service fan tray is adapted to temporarily provide cooling air to the embedded computer chassis absent the at least one primary fan tray.

In step 406, service fan tray is inserted into the cooling air plenum of embedded computer chassis. In step 408, service fan tray operates to provide cooling air temporarily to embedded computer chassis. In step 410, at least one primary fan tray discontinues operation and may be removed from embedded computer chassis. While at least one primary fan tray is not operating, service fan tray may provide cooling air to embedded computer chassis. In step 412, at least one primary fan tray is connected or reconnected to embedded computer chassis via fan tray receptacle. In step 414, service fan tray ceases operation and is disconnected from embedded computer chassis.

The above embodiments offer the advantage over the non-redundant embedded computer chassis of the prior art by allowing the insertion of a service fan tray in the cooling air plenum while the primary fan tray is taken off-line for service. This allows the embedded computer chassis to maintain operation even when it's at least one primary fan tray is out of service.

This paragraph describes the advantages of the proposed invention over the non-redundant prior art. The above embodiments also offer advantages over the redundant cooling of the prior art. For example, the service fan tray is simpler than redundant fan tray and therefore less expensive. Further, redundant fan trays of the prior art burden initial price of system with additional cost “for each system sold” whereas cost of service fan tray can be shared among many deployed systems. Due to the fact that the service fan tray is simpler and only needs to cool the system for a relatively short amount of time (for example 5-10 minutes), systems constructed using a service fan tray may be more compact than systems constructed using a redundant fan tray and this may significantly increase the number of systems we can fit into a rack and therefore the number of boards that can fit into a rack. The redundant fan tray solution has more fans running full time and therefore more fans that require periodic maintenance. The redundant fan tray solution has more fans running full time and therefore higher probability of encountering fan failure and therefore higher maintenance costs.

In the foregoing specification, the invention has been described with reference to specific exemplary embodiments. However, it will be appreciated that various modifications and changes may be made without departing from the scope of the present invention as set forth in the claims below. The specification and figures are to be regarded in an illustrative manner, rather than a restrictive one and all such modifications are intended to be included within the scope of the present invention. Accordingly, the scope of the invention should be determined by the claims appended hereto and their legal equivalents rather than by merely the examples described above.

For example, the steps recited in any method or process claims may be executed in any order and are not limited to the specific order presented in the claims. Additionally, the components and/or elements recited in any apparatus claims may be assembled or otherwise operationally configured in a variety of permutations to produce substantially the same result as the present invention and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

We claim:

1. An embedded computer chassis, comprising:
a fan tray receptacle adapted to receive at least one primary fan tray, wherein the at least one primary fan tray is adapted to be non-redundant in providing cooling air to the embedded computer chassis; and
a cooling air plenum, wherein the cooling air plenum is adapted to receive a service fan tray, wherein the service fan tray is adapted to temporarily provide the cooling air to the embedded computer chassis absent the at least one primary fan tray.

2. The embedded computer chassis of claim 1, further comprising:
an internal power source powering the at least one primary fan tray, and
an external power source powering the service fan tray, wherein the external power source is separate from the internal power source.

3. The embedded computer chassis of claim 2, wherein the external power source is a self-contained power source of the service fan tray.

4. The embedded computer chassis of claim 1, wherein an internal power source power source powers the at least one primary fan tray and the service fan tray.

5. The embedded computer chassis of claim 1, wherein the at least one primary fan tray is controlled via a control bus, and operating the service fan tray independently of the control bus.

6. The embedded computer chassis of claim 1, wherein the service fan tray comprises at least one service fan that operates at a single speed.

7. The embedded computer chassis of claim 1, wherein the service fan tray provides the cooling air for a limited time period.

8. The embedded computer chassis of claim 1, wherein the service fan tray operates without control logic.

9. A method of cooling an embedded computer chassis, comprising:
at least one primary fan tray providing cooling air to the embedded computer chassis, wherein the at least one primary fan tray is non-redundant in providing cooling air to the embedded computer chassis;
providing a cooling air plenum, wherein the cooling air plenum is adapted to receive a service fan tray, wherein the service fan tray is adapted to temporarily provide the cooling air to the embedded computer chassis absent the at least one primary fan tray;
inserting the service fan tray into the cooling air plenum;
the service fan tray operating to provide the cooling air temporarily to the embedded computer chassis; and
disconnecting the at least one primary fan tray from the embedded computer chassis.

10. The method of claim 9, further comprising:
an internal power source powering the at least one primary fan tray, and
an external power source powering the service fan tray, wherein the external power source is separate from the internal power source.

11. The method of clam 10, wherein the external power source is a self-contained power source of the service fan tray.

12. The method of claim 9, further comprising an internal power source power source powering the at least one primary fan tray and the service fan tray.

13. The method of claim 9, further comprising:
controlling the at least one primary fan tray via a control bus, and
operating the service fan tray independently of the control bus.

14. The method of claim 9, further comprising the service fan tray comprising at least one service fan operating at a single speed.

15. The method of claim 9, further comprising the service fan tray providing the cooling air for a limited time period.

16. The method of claim 9, further comprising operating the service fan tray without control logic.

17. The method of claim 9, further comprising:
reconnecting the at least one primary fan tray to the embedded computer chassis; and
disconnecting the service fan tray from the embedded computer chassis.

18. A service fan tray, comprising:
at least one service fan, wherein the service fan tray is adapted to interface with a cooling air plenum on an embedded computer chassis, wherein the at least one service fan is adapted to temporarily provide cooling air to the embedded computer chassis absent at least one primary fan tray, and wherein the at least one primary fan tray is adapted to be non-redundant in providing cooling air to the embedded computer chassis.

19. The service fan tray of claim 18, wherein the at least one service fan operates at a single speed.

20. The service fan tray of claim 18, wherein the service fan tray provides the cooling air for a limited time period.

21. The service fan tray of claim 18, wherein the service fan tray operates without control logic.

22. The service fan tray of claim 18, wherein the at least one service fan is powered by an external power source, wherein the external power source is separate from an internal power source powering the at least one primary fan tray.

23. The service fan tray of claim 18, wherein the at least one service fan is powered by an internal power source.
